(19) United States
(12) Patent Application Publication
(10) Pub. No.: US 2020/0190223 A1
(43) Pub. Date: Jun. 18, 2020

(54) SWELLABLE AND DISPERSIBLE BIOPOLYMER SUSPENSION

(71) Applicant: CARGILL, INCORPORATED, Wayzata, MN (US)

(72) Inventors: Jeffrey J. MALSAM, Minneapolis, MN (US); Eric Stanley SUMNER, Minneapolis, MN (US); Christopher J. TERVO, Minnetonka, MN (US)

(73) Assignee: CARGILL, INCORPORATED, Wayzata, MN (US)

(21) Appl. No.: 16/620,638

(22) PCT Filed: Jun. 7, 2018
(86) PCT No.: PCT/US2018/036476

§ 371 Date: Dec. 9, 2019

Related U.S. Application Data
(60) Provisional application No. 62/517,446, filed on Jun. 9, 2017.

(51) Int. Cl. C08B 37/00; C09K 8/588

(52) U.S. Cl. CPC C08B 37/0024; C09K 8/588

(57) ABSTRACT

Described herein is a flowable suspension comprising about 10-60 wt % of beta glucan with desirable swelling and dispersion properties.

### TECHNICAL FIELD

The present invention relates to the preparation of a beta glucan suspension with swelling and dispersion properties desired for enhanced oil recovery applications.

### BACKGROUND

Beta glucans are widely used as thickeners in enhanced oil recovery (EOR) applications. Particularly in off-shore applications, there is a desire to utilize such beta glucans, however given the limited amount of real estate it is desirable to receive the beta glucan in a solid or concentrated suspended form and quickly solubilize or dilute using the water on hand and minimal equipment. A drawback of scleroglucan polymer powder (a beta glucan) is its poor solubilization due to problems with dispersion in water. For suspensions, the active content and swelling properties of solids are important to quickly disperse and solubilize to provide desirable properties, for example filterability and viscosity, necessary for enhanced oil recovery operations. Methods have been investigated and studied in this regard, however each of these methods have presented limitations.

### BRIEF SUMMARY

Described herein is a flowable suspension comprising about 10-60 wt % of beta glucan (BG) that when diluted, under specified dilution procedure, has good dispersion of solids and high active content. Further described herein is a flowable suspension comprising about 10-60 wt % of BG wherein the solids are swelled to enhance solution preparation. Further described herein is a flowable suspension comprising about 10-60 wt % of BG wherein the solids are swelled to enhance active content in suspensions.

In some aspects, the suspension comprises about 10-60 wt % of beta glucan (BG) wherein the swelling of the suspended beta glucan ranges from about 120% to about 200%.

In some aspects, the swelling can range from about 125% to about 170%.

In some aspects, the swelling can range from about 130% to about 150%.

In some aspects, the suspension can comprise 30-60 wt % beta glucan.

In some aspects, the suspension can comprise 40-60 wt % beta glucan.

In some aspects, the suspension can comprise a hydrophilic solvent as a carrier fluid.

In some aspects, the suspension is flowable.

In some aspects, the suspension is dispersible.

In other aspects, the suspension comprises about 30-60 wt % of beta glucan wherein the swelling of the suspended beta glucan ranges from about 100% to about 140%.

In other aspects, the suspension comprise about 40-60 wt % of beta glucan wherein the swelling of the suspended beta glucan ranges from about 100% to about 135%.

In other aspects, the suspension comprises about 10-60 wt % of beta glucan (BG) wherein the swelling of the suspended beta glucan ranges from about 120% to about 200%.

In other aspects, the suspension comprises about 10-60 wt % of beta glucan (BG), the suspension being readily dispersible when diluted.

In some aspects, the suspension is at least partially swollen.

### DEFINITIONS

“Dispersible” is defined as a suspension wherein retained mass on the filter (˜1 mm square) during filtration of the suspension (diluted) is less than 25% of the mass of the pre-filtered suspension (diluted).

“Solid” is defined as a solid (i.e., not a liquid or gas) at standard atmospheric conditions. For the avoidance of doubt, the term “solid” includes powders, pressed or wet cakes, and solids surrounded by an alcohol solution or hydrophobic liquid.

“Suspension” is defined as a stable or unstable, heterogeneous mixture of solid or semi-solid beta glucan particles and a carrier fluid.

“Flowable” is defined as a suspension that retains at least 80% of the beta glucan solids when transferred according to the Transfer Procedure.

### DETAILED DESCRIPTION

Disclosed herein is a flowable suspension comprising beta glucan solids, that when diluted disperses faster and more readily than existing commercially available beta glucan solids. Also disclosed herein is a flowable suspension comprising beta glucan solids wherein the solids in suspension are swollen to enhance solubilization. Also disclosed herein is a flowable suspension comprising beta glucan solids wherein the beta glucan solids in suspension are lightly swollen to increase active content of beta glucan solids.

### Beta Glucan Solid Material

The beta glucans (“BG”) described in the present invention include polysaccharides classified as 1,3 beta-D-glucans, i.e., any polysaccharide which has a beta-(1,3)-linked backbone of D-glucose residues, and modifications thereof.

Fungal strains which secrete such glucans are known to those skilled in the art. Examples comprise Schizophyllum commune, Sclerotium rolfsii, Sclerotium glucanicum, Monilinla fructigena, Lentinula edodes or Botrygs cinera. The fungal strains used are preferably Schizophyllum commune or Sclerotium rolfsii.

Examples of such 1,3 beta-D-glucans include curdlan (a homopolymer of beta-(1,3)-linked D-glucose residues produced from, e.g., Agrobacterium spp.), grifolan (a branched beta-(1,3)-D-glucan produced from, e.g., the fungus Grifola frondosa), lentinan (a branched beta-(1,3)-D-glucan having two glucose branches attached at each fifth glucose residue of the beta-(1,3)-backbone produces from, e.g., the fungus Lentinus eeodes), schizophyllan (a branched beta-(1,3)-D-glucan having one glucose branch for every third glucose residue in the beta-(1,3)-backbone produced from, e.g., the fungus Schizophyllan commune), scleroglucan (a branched beta-(1,3)-D-glucan with one out of three glucose molecules of the beta-(1,3)-backbone being linked to a side D-glucose unit by a (1,6)-beta bond produced from, e.g., fungi of the Sclerotium spp.), SSG (a highly branched beta-(1,3)-glucan produced from, e.g., the fungus Sclerotinia sclerotiorum), soluble glucans from yeast (a beta-(1,3)-D-glucan with beta-(1,6)-linked side groups produced from, e.g., Saccharomyces cerevisiae), laminarin (a beta-(1,3)-glucan with beta-(1,3)-glucan and beta-(1,6)-glucan side groups produced from, e.g., the brown algae Laminaria digitata), and cereal glucans such as barley beta glucans (linear beta-(1,3)(1,4)-D-glucan produced from, e.g., Hordeum vulgare, Avena sativa, or Triticum vulgare).

Preferably, 1,3-1,6 beta-D-glucans, i.e., beta glucans comprising a main chain from beta-1,3-glycosidically bonded glucose units and side groups which are formed from glucose units and are beta-1,6-glycosidically bonded thereto, and modifications are used herein. Examples of such beta glucans are scleroglucan and schizophyllan.

### Suspension Comprising Beta-Glucan

In accordance with the present invention, solid beta glucan, as described above, can be included in a suspension to obtain a flowable suspension of beta glucan.

The carrier fluid for the suspension can generally be any fluid that will suspend or partially suspend a dispersion of solid beta glucan material. The beta glucan must not be readily soluble in the carrier fluid or the concentrated suspension may become too viscous (i.e., exceeds 2 million cP at 25° C.). It is also desirable to limit the hydration characteristics of the carrier fluid to limit hydration of the beta glucan being suspended. It shall also be understood that the particle size of the beta glucan will impact viscosity and other properties of the suspension. Accordingly, in creating the suspension, there is a balance between having larger beta glucan particle size (which may aid in the flowability of the suspension) and perhaps selecting a smaller beta glucan particle size (which may aid in solubilization).

It shall be understood that the beta glucan suspension may be amphiphilic, hydrophobic, or hydrophilic. Five preferred types of suspensions are contemplated herein: (1) solid beta glucan material in an immiscible hydrophobic carrier, (2) mixture of solid beta glucan material and alcohol in a hydrophobic carrier, (3) mixture of alcohol, water, and solid beta glucan material in alcohol, (4) solid beta glucan material in a hydrophobic system with reintroduced water, or (5) solid beta glucan material dispersed in an alcohol.

Accordingly, in aspects of the present invention, the carrier fluid can include various alcohols, glycols and glycol ethers such as ethylene glycol monobutyl ether (EGMBE), hexylene glycol, 2-methyl hexanol, propylene glycol n-butyl ether, ethylene glycol methyl ether, ethylene glycol ethyl ether, dipropylene glycol methyl ether, dipropylene glycol n-butyl ether, diethylene glycol ethyl ether, propylene glycol, diethylene glycol methyl ether, and the like.

Furthermore, the carrier fluid can include hydrophobic, non-water soluble organic liquids, particularly those having a Log K₀ value ranging from 0.1-10 and more preferably 0.3-8.5, wherein K₀ is the partition coefficient of a hydrophobic material in water. Examples of such hydrophobic liquids may be hydrocarbons such as alkanes (paraffins, isoparaffins) having the molecular formula CₙH₂ₙ₊₂, alkenes (olefins, alpha olefins, polyalphaolefins) having the molecular formula CₙH₂ₙ, various petroleum fractions such as mineral oils, diesel oil, white oils, and the like. Other water insoluble organic liquids which may be useful in this invention are terpenes, vegetable oils, carboxylic esters, malonic esters, sulfonic esters, limonene, alcohols containing 6 to 10 carbon atoms, and the like.

Swelling as described above is linked to hydrophilic properties of the carrier fluid. Accordingly, carrier fluids with greater hydrogen bonding have improved swelling capabilities over hydrophobic carrier fluids.

In the various aspects of the present invention, the suspension comprises about 10-60 wt % beta glucan, more preferably 20-50 wt %, and even more preferably 30-40 wt %. The suspension optionally can comprise one or more suspension, dispersing, or thinning agents and optionally may comprise a biocide.

### Swellable & Dispersible Suspension

The flowable beta glucan suspension described herein has desirable properties for EOR applications. When diluted under specified dilution procedure (which is further described below) the beta glucan suspension disperses more readily than the powder alone.

As to be understood, the specified dilution procedure generally involves blending the beta glucan suspension into an aqueous solution with limited shearing to get a desirable dispersion of beta-glucan in solution. Notably, the dispersion enables equipment and procedures that are suitable for off shore EOR applications and accommodate the limited real estate typically available in off shore EOR applications. Furthermore, the dispersion enables common technologies to be used such as pumping water and the beta-glucan suspension together in-line or adding the suspension to a lightly agitated tank of water.

Dilution of the beta glucan suspension can be carried out in either salt water or fresh water. Further, dilution may occur in pH conditions ranging from about 6 to about 8, and in temperature conditions ranging from about 10° C. to 120° C., in preferred aspects from 80° C. to 120° C., and in other preferred aspects from 20° C. to about 40° C. The first step in dilution is dispersion of the suspension comprising beta-glucan, as the suspension can be hydroscopic and therefore can form large particles that can be difficult for further processing. Dispersion can be done for example with eductors, in-line shearing devices, in addition to a tank and other common techniques used for handling concentrated suspensions and powders. In preferred aspects, low capital techniques such as mixing in a tank or pumping a concentrated suspension and water together with pipes are used. Beta glucan powders may lack desirable performance in these systems, so preferred aspects of the present invention include a suspension comprising beta glucan that enhances the dispersion of the beta glucan.

The beta glucan suspension described herein rapidly disperses into small particles using simple mixing techniques, like the described dilution procedure. “Dispersible” is defined as a suspension wherein retained mass on the filter (˜1 mm square) during filtration of the suspension is less than 25% of the mass of the pre-filtered suspension. In preferred aspects, the retained mass is less than 20% and in more preferred aspects less than 15%.

Furthermore, the beta glucan suspension is further improved when particles are optimally swollen by the carrier fluid. Such swelling improves dispersion and simplifies mixing of the suspension in water. The target swelling for the beta glucan solids in the suspension ranges from about 120% to about 200%, and in preferred aspects from about 125% to about 170%, and in more preferred aspects from about 130% to about 150%.

It is also desirable for EOR applications for the suspension to comprise a high active content of beta glucan to minimize shipping and handling costs and the costs associated with suspension fluid. Beta glucan suspensions comprising 10-60 wt % beta glucan are desirable as suspensions comprising beta-glucan content below 10 wt % are not economically attractive.

It shall be understood that carrier fluids resulting in lower swelling can result in an increase in the active content of beta glucan. Accordingly, it is desirable to balance swelling ability and active content to achieve an optimal balance. Particularly, suspensions comprising 30-60% active content and swelling ranging from 100-140% are preferred. In more preferred aspects suspensions comprising 40-60 wt % active content and swelling ranging from 100-135% are desirable.

### EXAMPLES

### Example 1

Swelling of CS11 in Ethanol

In a 250 mL low form ASTM E960 beaker, add 17.5 g of Cargill Actigum CS11® to 32.5 g of n-Heptane, a 35% solution (ambient temperature). Agitate the solution with a 1.5″ diameter Fisherbrand™ TFE Starburst Stirring Head at 300 rpm for 30 minutes. Individual HeadsIKA® Eurostar Power Control-Visc (PWR CV 51) set to 951 RPM with an IKA® R 1381 3-bladed impeller. Measure the mass of solution.

Weigh and put a Whatman® #4 70 mm filter paper into a matching sized Buchner funnel under 4″ H2O vacuum. Pass 3-10 mL of the solvent (ethanol) through the filter to wet the paper. Pour the transferred solution into the Buchner funnel to evenly coat the filter surface and continue to pull vacuum until no more filtrate flow is observed and a wet cake is formed.

Scrape the cake from the filter paper and measure the collected mass wet cake. Put the sample in a vacuum oven for 2 hours at 150C. Transfer material to atmospheric oven at 150C for an additional 14 hours. Remove the dry cake from the oven and measure its mass.

The measured masses are:

Solution mass after mixing: 49.7 grams

Wet cake mass: 21.3 grams

Dry cake mass: 15.7 grams

Swelling, wet cake mass/dry cake mass, is 161%.

### Example 2

Swelling of CS11 in n-Butanol

In a 250 mL low form ASTM E960 beaker, add 17.5 g of Cargill Actigum CS11® to 32.5 g of n-butanol, a 35% solution (ambient temperature). Agitate the solution with a 1.5″ diameter Fisherbrand™ TFE Starburst Stirring Head at 300 rpm for 30 minutes. Individual HeadslKA® Eurostar Power Control-Visc (PWR CV S1) set to 951 RPM with an IKA® R 1381 3-bladed impeller. Measure the mass of solution.

Weigh and put a Whatman® #4 70 mm filter paper into a matching sized Buchner funnel under 4″ H2O vacuum. Pass 3-10 mL of the solvent (n-butanol) through the filter to wet the paper. Pour the transferred solution into the Buchner funnel to evenly coat the filter surface and continue to pull vacuum until no more filtrate flow is observed and a wet cake is formed.

Scrape the cake from the filter paper and measure the collected mass wet cake. Put the sample in a vacuum oven for 2 hours at 150C. Transfer material to atmospheric oven at 150C for an additional 14 hours. Remove the dry cake from the oven and measure its mass.

The measured masses are:

Solution mass after mixing: 49.1 grams

Wet cake mass: 19 grams

Dry cake mass: 15.6 grams

Swelling, wet cake mass/dry cake mass, is 122%.

### Example 3

Swelling of CS11 in Dipropylene Glycol Methyl Ether (DPGME)

In a 250 mL low form ASTM E960 beaker, add 17.5 g of Cargill Actigum CS11® to 32.6 g of DPGME, a 35% solution (ambient temperature). Agitate the solution with a 1.5″ diameter Fisherbrand™ TFE Starburst Stirring Head at 300 rpm for 30 minutes. Individual HeadslKA® Eurostar Power Control-Visc (PWR CV 51) set to 951 RPM with an IKA® R 1381 3-bladed impeller. Measure the mass of solution.

Weigh and put a Whatman® #4 70 mm filter paper into a matching sized Buchner funnel under 4″ H2O vacuum. Pass 3-10 mL of the solvent (DPGME) through the filter to wet the paper. Pour the transferred solution into the Buchner funnel to evenly coat the filter surface and continue to pull vacuum until no more filtrate flow is observed and a wet cake is formed.

Scrape the cake from the filter paper and measure the collected mass wet cake. Put the sample in a vacuum oven for 2 hours at 150C. Transfer material to atmospheric oven at 150C for an additional 14 hours. Remove the dry cake from the oven and measure its mass.

The measured masses are:

Solution mass after mixing: 49.7 grams

Wet cake mass: 21.3 grams

Dry cake mass: 15.5 grams

Swelling, wet cake mass/dry cake mass, is 137%.

### Example 4

Swelling of CS11 in Isopropyl Alcohol (IPA)

In a 250 mL low form ASTM E960 beaker, add 17.5 g of Cargill Actigum CS11® to 32.5 g of IPA, a 35% solution (ambient temperature). Agitate the solution with a 1.5″ diameter Fisherbrand™ TFE Starburst Stirring Head at 300 rpm for 30 minutes. Individual HeadslKA® Eurostar Power Control-Visc (PWR CV 51) set to 951 RPM with an IKA® R 1381 3-bladed impeller. Measure the mass of solution.

Weigh and put a Whatman® #4 70 mm filter paper into a matching sized Buchner funnel under 4″ H2O vacuum. Pass 3-10 mL of the solvent (IPA) through the filter to wet the paper. Pour the transferred solution into the Buchner funnel to evenly coat the filter surface and continue to pull vacuum until no more filtrate flow is observed and a wet cake is formed.

Scrape the cake from the filter paper and measure the collected mass wet cake. Put the sample in a vacuum oven for 2 hours at 150C. Transfer material to atmospheric oven at 150C for an additional 14 hours. Remove the dry cake from the oven and measure its mass.

The measured masses are:

Solution mass after mixing: 48.2 grams

Wet cake mass: 21.1 grams

Dry cake mass: 15.4 grams

Swelling, wet cake mass/dry cake mass, is 137%.

### Example 5

Swelling of CS11 in 90% n-Butanol/10% H2O (90/10 Butanol/Water)

In a 250 mL low form ASTM E960 beaker, add 17.5 g of Cargill Actigum CS11® to 32.6 g of 90/10 Butanol/Water, a 35% solution (ambient temperature). Agitate the solution with a 1.5″ diameter Fisherbrand™ TFE Starburst Stirring Head at 300 rpm for 30 minutes. Individual HeadslKA® Eurostar Power Control-Visc (PWR CV 51) set to 951 RPM with an IKA® R 1381 3-bladed impeller. Measure the mass of solution.

Weigh and put a Whatman® #4 70 mm filter paper into a matching sized Buchner funnel under 4″ H2O vacuum. Pass 3-10 mL of the solvent (90/10 Butanol/Water) through the filter to wet the paper. Pour the transferred solution into the Buchner funnel to evenly coat the filter surface and continue to pull vacuum until no more filtrate flow is observed and a wet cake is formed.

Scrape the cake from the filter paper and measure the collected mass wet cake. Put the sample in a vacuum oven for 2 hours at 150C. Transfer material to atmospheric oven at 150C for an additional 14 hours. Remove the dry cake from the oven and measure its mass.

The measured masses are:

Solution mass after mixing: 49.7 grams

Wet cake mass: 21.8 grams

Dry cake mass: 15.5 grams

Swelling, wet cake mass/dry cake mass, is 141%.

### Example 6

Swelling of CS11 in n-Hexane

In a 250 mL low form ASTM E960 beaker, add 17.5 g of Cargill Actigum CS11® to 32.6 g of n-hexane, a 35% solution (ambient temperature). Agitate the solution with a 1.5″ diameter Fisherbrand™ TFE Starburst Stirring Head at 300 rpm for 30 minutes. Individual HeadslKA® Eurostar Power Control-Visc (PWR CV 51) set to 951 RPM with an IKA® R 1381 3-bladed impeller. Measure the mass of solution.

Weigh and put a Whatman® #4 70 mm filter paper into a matching sized Buchner funnel under 4″ H2O vacuum. Pass 3-10 mL of the solvent (n-hexane) through the filter to wet the paper. Pour the transferred solution into the Buchner funnel to evenly coat the filter surface and continue to pull vacuum until no more filtrate flow is observed and a wet cake is formed.

Scrape the cake from the filter paper and measure the collected mass wet cake. Put the sample in a vacuum oven for 2 hours at 150C. Transfer material to atmospheric oven at 150C for an additional 14 hours. Remove the dry cake from the oven and measure its mass.

The measured masses are:

Solution mass after mixing: 48.3 grams

Wet cake mass: 17.8 grams

Dry cake mass: 15.5 grams

Swelling, wet cake mass/dry cake mass, is 115%.

### Example 7

Swelling of CS11 in n-Pentanol (Pentanol)

In a 250 mL low form ASTM E960 beaker, add 17.5 g of Cargill Actigum CS11® to 32.5 g of pentanol, a 35% solution (ambient temperature). Agitate the solution with a 1.5″ diameter Fisherbrand™ TFE Starburst Stirring Head at 300 rpm for 30 minutes. Individual HeadslKA® Eurostar Power Control-Visc (PWR CV 51) set to 951 RPM with an IKA® R 1381 3-bladed impeller. Measure the mass of solution.

Weigh and put a Whatman® #4 70 mm filter paper into a matching sized Buchner funnel under 4″ H2O vacuum. Pass 3-10 mL of the solvent (pentanol) through the filter to wet the paper. Pour the transferred solution into the Buchner funnel to evenly coat the filter surface and continue to pull vacuum until no more filtrate flow is observed and a wet cake is formed.

Scrape the cake from the filter paper and measure the collected mass wet cake. Put the sample in a vacuum oven for 2 hours at 150C. Transfer material to atmospheric oven at 150C for an additional 14 hours. Remove the dry cake from the oven and measure its mass.

The measured masses are:

Solution mass after mixing: 49.6 grams

Wet cake mass: 20.1 grams

Dry cake mass: 15.2 grams

Swelling, wet cake mass/dry cake mass, is 132%.

### Example 8

Swelling of CS11 in n-Octanol (Octanol)

In a 250 mL low form ASTM E960 beaker, add 17.5 g of Cargill Actigum CS11® to 32.5 g of octanol, a 35% solution (ambient temperature). Agitate the solution with a 1.5″ diameter Fisherbrand™ TFE Starburst Stirring Head at 300 rpm for 30 minutes. Individual HeadslKA® Eurostar Power Control-Visc (PWR CV 51) set to 951 RPM with an IKA® R 1381 3-bladed impeller. Measure the mass of solution.

Weigh and put a Whatman® #4 70 mm filter paper into a matching sized Buchner funnel under 4″ H2O vacuum. Pass 3-10 mL of the solvent (octanol) through the filter to wet the paper. Pour the transferred solution into the Buchner funnel to evenly coat the filter surface and continue to pull vacuum until no more filtrate flow is observed and a wet cake is formed.

Scrape the cake from the filter paper and measure the collected mass wet cake. Put the sample in a vacuum oven for 2 hours at 150C. Transfer material to atmospheric oven at 150C for an additional 14 hours. Remove the dry cake from the oven and measure its mass.

The measured masses are:

Solution mass after mixing: 49.6 grams

Wet cake mass: 21.4 grams

Dry cake mass: 15.3 grams

Swelling, wet cake mass/dry cake mass, is 140%.

### Example 9

Dispersion of CS11 and Isopropyl Alcohol into Water

In a 600 mL low form ASTM E960 beaker, add 2.5 g of Cargill Actigum CS11® to 5.8 g of isopropyl alcohol, a 30% solution (ambient temperature). Mix until a uniform solution. Connect the middle of a 50″ Masterflex® Tygon LFL 0.25″ diameter tubing to a Masterflex® Variable-Speed Drive model EW-07559-00 pump. Place one end of the tube near the bottom of a 2 liter beaker of water and connect the other end to a Pall stainless steel filter funnel (4280). Orient the pall filter vertically above the 600 mL beaker filled with suspension such that the tip of the discharge pipe is in the middle horizontally and aligned with the top of the beaker vertically. Turn the pump on to a setting of 10 and transfer approximately 500 grams of solution. Measure the total mass of solution.

Place the beaker on a magnetic stir plate and add a Fisherbrand™ Octagonal Magnetic Stir Bars (14-513-67, 9.4 mm by 63.5 mm) and stir at 300 rpm for 60 seconds. Remove the magnet from the beaker and pour solution in 3 to 7 seconds through an Oxo 3″ mini-strainer (part number 21105000 with ˜1 mm mesh hole size). Note the presence on any visible solids and measure the mass collected in the strainer. Collect the filtrate and measure the solution viscosity using a Brookfield Ametek® LVT viscometer in a beaker with at least 2 centimeters (cm between spindle and the wall) (all examples referencing viscosity use this method). Scrape solids from the mesh and surfaces of the beaker and weigh.

The measured masses are:

Solution mass after adding water: 495.3 grams

No visual solids collected on the mesh screen.

Measured mass increase on mesh screen: 0.5 grams

Measured mass of collected solids from screen and beaker: 0 grams

Filtrate viscosity: 20 cp at 6 rpm, 2 cp at 30 rpm, and 6 cp at 60 rpm

### Example 10

Dispersion of CS11 Powder into Water

In a 600 mL low form ASTM E960 beaker, add 2.5 g of Cargill Actigum CS11® powder to bottom of beaker, spreading it evenly over the surface (ambient temperature). Connect the middle of a 50″ Masterflex® Tygon LFL 0.25″ diameter tubing to a Masterflex® Variable-Speed Drive model EW-07559-00 pump. Place one end of the tube near the bottom of a 2 liter beaker of water and connect the other end to a Pall stainless steel filter funnel (4280). Orient the pall filter vertically above the 600 mL beaker filled with suspension such that the tip of the discharge pipe is in the middle horizontally and aligned with the top of the beaker vertically. Turn the pump on to a setting of 10 and transfer approximately 500 grams of solution. Measure the total mass of solution.

Place the beaker on a magnetic stir plate and add a Fisherbrand™ Octagonal Magnetic Stir Bars (14-513-67, 9.4 mm by 63.5 mm) and stir at 300 rpm for 60 seconds. Remove the magnet from the beaker and pour solution in 3 to 7 seconds through an Oxo 3″ mini-strainer (part number 21105000 with ˜1 mm mesh hole size). Note the presence on any visible solids and measure the mass collected in the strainer. As a secondary measure, weigh solids scraped from the mesh and surfaces of the beaker.

The measured masses are:

Solution mass after adding water: 478.5 grams

Significant solids on mesh and some stuck to surfaces of beaker.

Measured mass increase on mesh screen: 4.5 grams

Measured mass of collected solids from screen and beaker: 4.2 grams

Filtrate viscosity: 15 cp at 6 pm, 3 cp at 30 rpm, and 4 cp at 60 rpm

### Example 11

Dispersion of CS11 and n-Heptane into Water

In a 600 mL low form ASTM E960 beaker, add 2.5 g of Cargill Actigum CS11® to 5.8 g of n-heptane, a 30% solution (ambient temperature). Mix until a uniform solution. Connect the middle of a 50″ Masterflex® Tygon LFL 0.25″ diameter tubing to a Masterflex® Variable-Speed Drive model EW-07559-00 pump. Place one end of the tube near the bottom of a 2 liter beaker of water and connect the other end to a Pall stainless steel filter funnel (4280). Orient the pall filter vertically above the 600 mL beaker filled with suspension such that the tip of the discharge pipe is in the middle horizontally and aligned with the top of the beaker vertically. Turn the pump on to a setting of 10 and transfer approximately 500 grams of solution. Measure the total mass of solution.

Place the beaker on a magnetic stir plate and add a Fisherbrand™ Octagonal Magnetic Stir Bars (14-513-67, 9.4 mm by 63.5 mm) and stir at 300 rpm for 60 seconds. Remove the magnet from the beaker and pour solution in 3 to 7 seconds through an Oxo 3″ mini-strainer (part number 21105000 with ˜1 mm mesh hole size). Note the presence on any visible solids and measure the mass collected in the strainer. As a secondary measure, weigh solids scraped from the mesh and surfaces of the beaker.

The measured masses are:

Solution mass after adding water: 499.1 grams

No visual solids collected on the mesh screen.

Measured mass increase on mesh screen: 2.0 grams

Measured mass of collected solids from screen and beaker: 1.5 grams

Filtrate viscosity: 5 cp at 6 pm, 6 cp at 30 rpm, and 6.5 cp at 60 rpm

### Example 12

Dispersion of CS11 Powder into Water

In a 600 mL low form ASTM E960 beaker, add 2.5 g of Cargill Actigum CS11® powder to bottom of beaker, spreading it evenly over the surface (ambient temperature). Connect the middle of a 50″ Masterflex® Tygon LFL 0.25″ diameter tubing to a Masterflex® Variable-Speed Drive model EW-07559-00 pump. Place one end of the tube near the bottom of a 2 liter beaker of water and connect the other end to a Pall stainless steel filter funnel (4280). Orient the pall filter vertically above the 600 mL beaker filled with suspension such that the tip of the discharge pipe is in the middle horizontally and aligned with the top of the beaker vertically. Turn the pump on to a setting of 10 and transfer approximately 500 grams of solution. Measure the total mass of solution.

Place the beaker on a magnetic stir plate and add a Fisherbrand™ Octagonal Magnetic Stir Bars (14-513-67, 9.4 mm by 63.5 mm) and stir at 300 rpm for 60 seconds. Remove the magnet from the beaker and pour solution in 3 to 7 seconds through an Oxo 3″ mini-strainer (part number 21105000 with ˜1 mm mesh hole size). Note the presence on any visible solids and measure the mass collected in the strainer. As a secondary measure, weigh solids scraped from the mesh and surfaces of the beaker.

The measured masses are:

Solution mass after adding water: 493.8 grams

Significant solids on mesh and some stuck to surfaces of beaker.

Measured mass increase on mesh screen: 5.6 grams

Measured mass of collected solids from screen and beaker: 7.3 grams

Filtrate viscosity: 5 cp at 6 pm, 1 cp at 30 rpm, and 3.5 cp at 60 rpm

### Example 13

Dispersion of CS11 and n-Butanol into Water

In a 600 mL low form ASTM E960 beaker, add 2.5 g of Cargill Actigum CS11® to 5.8 g of n-butanol, a 30% solution (ambient temperature). Mix until a uniform solution. Connect the middle of a 50″ Masterflex® Tygon LFL 0.25″ diameter tubing to a Masterflex® Variable-Speed Drive model EW-07559-00 pump. Place one end of the tube near the bottom of a 2 liter beaker of water and connect the other end to a Pall stainless steel filter funnel (4280). Orient the pall filter vertically above the 600 mL beaker filled with suspension such that the tip of the discharge pipe is in the middle horizontally and aligned with the top of the beaker vertically. Turn the pump on to a setting of 10 and transfer approximately 500 grams of solution. Measure the total mass of solution.

Place the beaker on a magnetic stir plate and add a Fisherbrand™ Octagonal Magnetic Stir Bars (14-513-67, 9.4 mm by 63.5 mm) and stir at 300 rpm for 60 seconds. Remove the magnet from the beaker and pour solution in 3 to 7 seconds through an Oxo 3″ mini-strainer (part number 21105000 with ˜1 mm mesh hole size). Note the presence on any visible solids and measure the mass collected in the strainer. As a secondary measure, weigh solids scraped from the mesh and surfaces of the beaker.

The measured masses are:

Solution mass after adding water: 499.9 grams

No visual solids collected on the mesh screen.

Measured mass increase on mesh screen: 0.7 grams

Measured mass of collected solids from screen and beaker: 0 grams

Filtrate viscosity: 20 cp at 6 pm, 7.5 cp at 30 rpm, and 5.5 cp at 60 rpm

### Example 14

Dispersion of CS11 and Tween 20 into Water

In a 600 mL low form ASTM E960 beaker, add 2.5 g of Cargill Actigum CS11® to 5.8 g of Tween® 20, a 30% solution (ambient temperature). Mix until a uniform solution. Connect the middle of a 50″ Masterflex® Tygon LFL 0.25″ diameter tubing to a Masterflex® Variable-Speed Drive model EW-07559-00 pump. Place one end of the tube near the bottom of a 2 liter beaker of water and connect the other end to a Pall stainless steel filter funnel (4280). Orient the pall filter vertically above the 600 mL beaker filled with suspension such that the tip of the discharge pipe is in the middle horizontally and aligned with the top of the beaker vertically. Turn the pump on to a setting of 10 and transfer approximately 500 grams of solution. Measure the total mass of solution.

Place the beaker on a magnetic stir plate and add a Fisherbrand™ Octagonal Magnetic Stir Bars (14-513-67, 9.4 mm by 63.5 mm) and stir at 300 rpm for 60 seconds. Remove the magnet from the beaker and pour solution in 3 to 7 seconds through an Oxo 3″ mini-strainer (part number 21105000 with ˜1 mm mesh hole size). Note the presence on any visible solids and measure the mass collected in the strainer. As a secondary measure, weigh solids scraped from the mesh and surfaces of the beaker.

The measured masses are:

Solution mass after adding water: 495.9 grams

No visual solids on mesh screen, thicker liquid layer.

Measured mass increase on mesh screen: 1.7 grams

Measured mass of collected solids from screen and beaker: 0 grams

Filtrate viscosity: 15 cp at 6 pm, 4 cp at 30 rpm, and 5.5 cp at 60 rpm

### Example 15

Dispersion of CS11 and Mineral Oil into Water

In a 600 mL low form ASTM E960 beaker, add 2.5 g of Cargill Actigum CS11® to 5.8 g of mineral oil, a 30% solution (ambient temperature). Mix until a uniform solution. Connect the middle of a 50″ Masterflex® Tygon LFL 0.25″ diameter tubing to a Masterflex® Variable-Speed Drive model EW-07559-00 pump. Place one end of the tube near the bottom of a 2 liter beaker of water and connect the other end to a Pall stainless steel filter funnel (4280). Orient the pall filter vertically above the 600 mL beaker filled with suspension such that the tip of the discharge pipe is in the middle horizontally and aligned with the top of the beaker vertically. Turn the pump on to a setting of 10 and transfer approximately 500 grams of solution. Measure the total mass of solution.

Place the beaker on a magnetic stir plate and add a Fisherbrand™ Octagonal Magnetic Stir Bars (14-513-67, 9.4 mm by 63.5 mm) and stir at 300 rpm for 60 seconds. Remove the magnet from the beaker and pour solution in 3 to 7 seconds through an Oxo 3″ mini-strainer (part number 21105000 with ˜1 mm mesh hole size). Note the presence on any visible solids and measure the mass collected in the strainer. As a secondary measure, weigh solids scraped from the mesh and surfaces of the beaker.

The measured masses are:

Solution mass after adding water: 499.9 grams

Small amount of small solids mesh screen and beaker surface.

Measured mass increase on mesh screen: 1.2 grams

Measured mass of collected solids from screen and beaker: 0.3 grams

Filtrate viscosity: 20 cp at 6 pm, 3 cp at 30 rpm, and 7.5 cp at 60 rpm

### Example 16

Dispersion of CS11 and Ethanol into Water

In a 600 mL low form ASTM E960 beaker, add 2.5 g of Cargill Actigum CS11® to 5.8 g of ethanol, a 30% solution (ambient temperature). Mix until a uniform solution. Connect the middle of a 50″ Masterflex® Tygon LFL 0.25″ diameter tubing to a Masterflex® Variable-Speed Drive model EW-07559-00 pump. Place one end of the tube near the bottom of a 2 liter beaker of water and connect the other end to a Pall stainless steel filter funnel (4280). Orient the pall filter vertically above the 600 mL beaker filled with suspension such that the tip of the discharge pipe is in the middle horizontally and aligned with the top of the beaker vertically. Turn the pump on to a setting of 10 and transfer approximately 500 grams of solution. Measure the total mass of solution.

Place the beaker on a magnetic stir plate and add a Fisherbrand™ Octagonal Magnetic Stir Bars (14-513-67, 9.4 mm by 63.5 mm) and stir at 300 rpm for 60 seconds. Remove the magnet from the beaker and pour solution in 3 to 7 seconds through an Oxo 3″ mini-strainer (part number 21105000 with ˜1 mm mesh hole size). Note the presence on any visible solids and measure the mass collected in the strainer. As a secondary measure, weigh solids scraped from the mesh and surfaces of the beaker.

The measured masses are:

Solution mass after adding water: 487.7 grams

No visible solids on mesh screen

Measured mass increase on mesh screen: 0.7 grams

Measured mass of collected solids from screen and beaker: 0 grams

Filtrate viscosity: 5 cp at 6 pm, 2 cp at 30 rpm, and 5.5 cp at 60 rpm

### Example 17

Dispersion of CS11 and Isopropyl Alcohol (IPA) into Water

In a 600 mL low form ASTM E960 beaker, add 2.5 g of Cargill Actigum CS11® to 5.8 g of IPA, a 30% solution (ambient temperature). Mix until a uniform solution. Connect the middle of a 50″ Masterflex® Tygon LFL 0.25″ diameter tubing to a Masterflex® Variable-Speed Drive model EW-07559-00 pump. Place one end of the tube near the bottom of a 2 liter beaker of water and connect the other end to a Pall stainless steel filter funnel (4280). Orient the pall filter vertically above the 600 mL beaker filled with suspension such that the tip of the discharge pipe is in the middle horizontally and aligned with the top of the beaker vertically. Turn the pump on to a setting of 10 and transfer approximately 500 grams of solution. Measure the total mass of solution.

Place the beaker on a magnetic stir plate and add a Fisherbrand™ Octagonal Magnetic Stir Bars (14-513-67, 9.4 mm by 63.5 mm) and stir at 300 rpm for 60 seconds. Remove the magnet from the beaker and pour solution in 3 to 7 seconds through an Oxo 3″ mini-strainer (part number 21105000 with ˜1 mm mesh hole size). Note the presence on any visible solids and measure the mass collected in the strainer. As a secondary measure, weigh solids scraped from the mesh and surfaces of the beaker.

The measured masses are:

Solution mass after adding water: 482.3 grams

No visible solids on mesh screen

Measured mass increase on mesh screen: 0.3 grams

Measured mass of collected solids from screen and beaker: 0 grams

Filtrate viscosity: 10 cp at 6 pm, 3 cp at 30 rpm, and 5.5 cp at 60 rpm

### Example 18

Dispersion of CS11 and n-Pentanol(Pentanol) into Water

In a 600 mL low form ASTM E960 beaker, add 2.5 g of Cargill Actigum CS11® to 5.8 g of pentanol, a 30% solution (ambient temperature). Mix until a uniform solution. Connect the middle of a 50″ Masterflex® Tygon LFL 0.25″ diameter tubing to a Masterflex® Variable-Speed Drive model EW-07559-00 pump. Place one end of the tube near the bottom of a 2 liter beaker of water and connect the other end to a Pall stainless steel filter funnel (4280). Orient the pall filter vertically above the 600 mL beaker filled with suspension such that the tip of the discharge pipe is in the middle horizontally and aligned with the top of the beaker vertically. Turn the pump on to a setting of 10 and transfer approximately 500 grams of solution. Measure the total mass of solution.

Place the beaker on a magnetic stir plate and add a Fisherbrand™ Octagonal Magnetic Stir Bars (14-513-67, 9.4 mm by 63.5 mm) and stir at 300 rpm for 60 seconds. Remove the magnet from the beaker and pour solution in 3 to 7 seconds through an Oxo 3″ mini-strainer (part number 21105000 with ˜1 mm mesh hole size). Note the presence on any visible solids and measure the mass collected in the strainer. As a secondary measure, weigh solids scraped from the mesh and surfaces of the beaker.

The measured masses are:

Solution mass after adding water: 499 grams

No visible solids on mesh screen.

Measured mass increase on mesh screen: 1 grams

Measured mass of collected solids from screen and beaker: 0.3 grams

Filtrate viscosity: 0 cp at 6 pm, 3 cp at 30 rpm, and 6.5 cp at 60 rpm

### Example 19

Dispersion of CS11 and n-Octanol(Octanol) into Water

In a 600 mL low form ASTM E960 beaker, add 2.5 g of Cargill Actigum CS11® to 5.8 g of octanol, a 30% solution (ambient temperature). Mix until a uniform solution. Connect the middle of a 50″ Masterflex® Tygon LFL 0.25″ diameter tubing to a Masterflex® Variable-Speed Drive model EW-07559-00 pump. Place one end of the tube near the bottom of a 2 liter beaker of water and connect the other end to a Pall stainless steel filter funnel (4280). Orient the pall filter vertically above the 600 mL beaker filled with suspension such that the tip of the discharge pipe is in the middle horizontally and aligned with the top of the beaker vertically. Turn the pump on to a setting of 10 and transfer approximately 500 grams of solution. Measure the total mass of solution.

Place the beaker on a magnetic stir plate and add a Fisherbrand™ Octagonal Magnetic Stir Bars (14-513-67, 9.4 mm by 63.5 mm) and stir at 300 rpm for 60 seconds. Remove the magnet from the beaker and pour solution in 3 to 7 seconds through an Oxo 3″ mini-strainer (part number 21105000 with ˜1 mm mesh hole size). Note the presence on any visible solids and measure the mass collected in the strainer. As a secondary measure, weigh solids scraped from the mesh and surfaces of the beaker.

The measured masses are:

Solution mass after adding water: 494.5 grams

No visible solids on mesh screen.

Measured mass increase on mesh screen: 0.7 grams

Measured mass of collected solids from screen and beaker: 0 grams

Filtrate viscosity: 5 cp at 6 pm, 2 cp at 30 rpm, and 5.5 cp at 60 rpm

### Example 20

Dispersion of CS11 and Dipropylene Glycol Methyl Ether (DPGME) into Water

In a 600 mL low form ASTM E960 beaker, add 2.5 g of Cargill Actigum CS11® to 5.8 g of DPGME, a 30% solution (ambient temperature). Mix until a uniform solution. Connect the middle of a 50″ Masterflex® Tygon LFL 0.25″ diameter tubing to a Masterflex® Variable-Speed Drive model EW-07559-00 pump. Place one end of the tube near the bottom of a 2 liter beaker of water and connect the other end to a Pall stainless steel filter funnel (4280). Orient the pall filter vertically above the 600 mL beaker filled with suspension such that the tip of the discharge pipe is in the middle horizontally and aligned with the top of the beaker vertically. Turn the pump on to a setting of 10 and transfer approximately 500 grams of solution. Measure the total mass of solution.

Place the beaker on a magnetic stir plate and add a Fisherbrand™ Octagonal Magnetic Stir Bars (14-513-67, 9.4 mm by 63.5 mm) and stir at 300 rpm for 60 seconds. Remove the magnet from the beaker and pour solution in 3 to 7 seconds through an Oxo 3″ mini-strainer (part number 21105000 with ˜1 mm mesh hole size). Note the presence on any visible solids and measure the mass collected in the strainer. As a secondary measure, weigh solids scraped from the mesh and surfaces of the beaker.

The measured masses are:

Solution mass after adding water: 494.2 grams

No visible solids on mesh screen.

Measured mass increase on mesh screen: 0.3 grams

Measured mass of collected solids from screen and beaker: 0 grams

Filtrate viscosity: 5 cp at 6 pm, below detection at 30 rpm, and 4 cp at 60 rpm

### Example 21

Dispersion of CS11 and Canola Oil (Oil) into Water

In a 600 mL low form ASTM E960 beaker, add 2.5 g of Cargill Actigum CS11® to 5.8 g of oil, a 30% solution (ambient temperature). Mix until a uniform solution. Connect the middle of a 50″ Masterflex® Tygon LFL 0.25″ diameter tubing to a Masterflex® Variable-Speed Drive model EW-07559-00 pump. Place one end of the tube near the bottom of a 2 liter beaker of water and connect the other end to a Pall stainless steel filter funnel (4280). Orient the pall filter vertically above the 600 mL beaker filled with suspension such that the tip of the discharge pipe is in the middle horizontally and aligned with the top of the beaker vertically. Turn the pump on to a setting of 10 and transfer approximately 500 grams of solution. Measure the total mass of solution.

Place the beaker on a magnetic stir plate and add a Fisherbrand™ Octagonal Magnetic Stir Bars (14-513-67, 9.4 mm by 63.5 mm) and stir at 300 rpm for 60 seconds. Remove the magnet from the beaker and pour solution in 3 to 7 seconds through an Oxo 3″ mini-strainer (part number 21105000 with ˜1 mm mesh hole size). Note the presence on any visible solids and measure the mass collected in the strainer. As a secondary measure, weigh solids scraped from the mesh and surfaces of the beaker.

The measured masses are:

Solution mass after adding water: 536.5 grams

Two phase mixture and mesh coated in viscous oil as well as some solids.

Measured mass increase on mesh screen: 5 grams

Measured mass of collected solids from screen and beaker: 1.3 grams

Filtrate viscosity: 15 cp at 6 pm, 1 cp at 30 rpm, and 4.5 cp at 60 rpm

### Example 22

Dispersion of Beta-Glucan Described Herein and 90% n-Butanol/10% H2O (90/10 Butanol) into Water

In a 600 mL low form ASTM E960 beaker, add 2.5 g of beta-glucan described in Example 27 to 5.8 g of 90/10 butanol, a 30% solution (ambient temperature). Mix until a uniform solution. Connect the middle of a 50″ Masterflex® Tygon LFL 0.25″ diameter tubing to a Masterflex® Variable-Speed Drive model EW-07559-00 pump. Place one end of the tube near the bottom of a 2 liter beaker of water and connect the other end to a Pall stainless steel filter funnel (4280). Orient the pall filter vertically above the 600 mL beaker filled with suspension such that the tip of the discharge pipe is in the middle horizontally and aligned with the top of the beaker vertically. Turn the pump on to a setting of 10 and transfer approximately 500 grams of solution. Measure the total mass of solution.

Place the beaker on a magnetic stir plate and add a Fisherbrand™ Octagonal Magnetic Stir Bars (14-513-67, 9.4 mm by 63.5 mm) and stir at 300 rpm for 60 seconds. Remove the magnet from the beaker and pour solution in 3 to 7 seconds through an Oxo 3″ mini-strainer (part number 21105000 with ˜1 mm mesh hole size). Note the presence on any visible solids and measure the mass collected in the strainer. As a secondary measure, weigh solids scraped from the mesh and surfaces of the beaker.

The measured masses are:

Solution mass after adding water: 493.8 grams

No visible solids on mesh screen.

Measured mass increase on mesh screen: 1.4 grams

Measured mass of collected solids from screen and beaker: 0 grams

Filtrate viscosity: 190 cp at 6 pm, 94 cp at 30 rpm, and 60 cp at 60 rpm

With some water to help hydration, this solution is particular good at dispersion with a significant build in viscosity of the solution.

### Example 23

Swelling of EOR Beta-Glucan in 90% n-Butanol/10% H2O (90/10 Butanol/Water)

In a 250 mL low form ASTM E960 beaker, add 17.5 g of beta-glucan described in Example 27 to 32.5 g of 90/10 Butanol/Water, a 35% solution (ambient temperature). Agitate the solution with a 1.5″ diameter Fisherbrand™ TFE Starburst Stirring Head at 300 rpm for 30 minutes. Individual HeadslKA® Eurostar Power Control-Visc (PWR CV S1) set to 951 RPM with an IKA® R 1381 3-bladed impeller. Measure the mass of solution.

Weigh and put a Whatman® #4 70 mm filter paper into a matching sized Buchner funnel under 4″ H2O vacuum. Pass 3-10 mL of the solvent (90/10 Butanol/Water) through the filter to wet the paper. Pour the transferred solution into the Buchner funnel to evenly coat the filter surface and continue to pull vacuum until no more filtrate flow is observed and a wet cake is formed. Measure the mass of the wet cake.

The measured masses are:

Solution mass after mixing: 48.5 grams

Wet cake mass: 29.9 grams

Dry cake mass: 16.0 grams

Swelling, wet cake mass/dry cake mass, is 187%.

### Example 24

Swelling of CS11 in Water

In a 250 mL low form ASTM E960 beaker, add 17.5 g of Cargill Actigum CS11® to 32.5 g of water, a 35% solution (ambient temperature). Agitate the solution with a 1.5″ diameter Fisherbrand™ TFE Starburst Stirring Head at 300 rpm for 30 minutes. Individual HeadslKA® Eurostar Power Control-Visc (PWR CV S1) set to 951 RPM with an IKA® R 1381 3-bladed impeller. Measure the mass of solution.

Weigh and put a Whatman® #4 70 mm filter paper into a matching sized Buchner funnel under 4″ H2O vacuum. Pass 3-10 mL of the solvent (water) through the filter to wet the paper. Pour the transferred solution into the Buchner funnel to evenly coat the filter surface and continue to pull vacuum until no more filtrate flow is observed and a wet cake is formed.

Scrape the cake from the filter paper and measure the collected mass wet cake. Put the sample in a vacuum oven for 2 hours at 150C. The single clump had a dry exterior and drying slowed, so it was broken into pieces and stored and additional 14 hours in an atmospheric oven at 150C. Remove the dry cake from the oven and measure its mass.

The measured masses are:

Solution mass after mixing: 49.3 grams

Wet cake mass: 47.3 grams

Dry cake mass: 15.5 grams

Swelling, wet cake mass/dry cake mass, is 306%.

### Example 25

Transfer Procedure

The directions for the transfer procedure referenced in the above examples is as follows:
1. Agitate suspension with an IKA® Eurostar Power Control-Visc (PWR CV S1) set to a RPM ranging from 500-2000 RPM with an IKA® R 1381 3-bladed impeller.
2. Mount the bottom of the impeller blade in the middle of the beaker 8.5 mm above the bottom. Connect the middle of a 50″ Masterflex0 Tygon LFL 0.25″ diameter tubing to a Masterflex® Variable-Speed Drive model EW-07559-00 pump. Place one end of the tube in the suspension above the base of the beaker and just below the bottom of the agitator and the other in a second empty 600 mL beaker such that the two beakers are level and on the same elevation.
3. Turn the pump on to a setting of 7 and transfer approximately 135 grams of solution, stopping as soon as liquid drops below the bottom of the agitator but still covers the tubing inlet. Measure the mass of solution.
4. Weigh and put a Whatman® #4 125 mm filter paper into a Coors® 60246 Buchner funnel under 4″ H2O vacuum such that filtrate is pulled into the collection flask. Pass some of the carrier fluid through the filter to wet the paper. Pour the transferred solution into the Buchner funnel and continue to pull vacuum until no more filtrate flow is observed.
5. Over 30 seconds uniformly rinse the cake with solvent while manually agitating the cake with a spatula while avoiding disturbing the filter. Stop once filtrate flow ceases and a wet cake is clearly formed.
6. Recover the wet cake and filter paper and put into a 20 mmHg vacuum oven at 150C for drying. After two hours, transfer cake to an atmospheric oven at 150C for 14 to 20 hours. Remove the filter cake from the oven and weigh the dry cake and filter paper.
7. For the dried transferred solution calculate the mass concentration of solids to compare against initial solution.
8. Carry out calculations by comparing mass of solids to the mass of solution: (mass of dry cake+paper—mass of dry paper)/(mass of solution).

### Example 26

Additional Swelling & Dispersion Data

Tables 1 and 2 provide additional swelling and dispersion data, respectively for some of the examples above.

TABLE 1

| | | | | | Solution | | | | | | |
|---|---|---|---|---|---|---|---|---|---|---|---|
| | | Mass | Mass | | after 30 | Filter wet | Dried | Transferred % | Swell % | Mass | Oven |
| Solvent | SG | Solvent | SG | % SG | minutes | cake | Cake | Solids | Increase | Balance | Method |
| Ethanol | CS11 | 32.5 | 17.5 | 35% | 46.1 | 25.3 | 15.7 | 34% | 161% | 98% | 150 C. 2 |
| | | | | | | | | | | | hours |
| Butanol | CS11 | 32.5 | 17.5 | 35% | 49.1 | 19 | 15.6 | 32% | 122% | 97% | 150 C. 2 |
| | | | | | | | | | | | hours |
| DPGME | CS11 | 32.6 | 17.5 | 35% | 49.7 | 21.3 | 15.5 | 31% | 137% | 96% | 150 C. 2 |
| | | | | | | | | | | | hours |
| IPA | CS11 | 32.5 | 17.5 | 35% | 48.2 | 21.1 | 15.4 | 32% | 137% | 97% | 150 C. 2 |
| | | | | | | | | | | | hours |
| 90 Butanol/ | CS11 | 32.6 | 17.5 | 35% | 49.7 | 21.8 | 15.5 | 31% | 141% | 98% | 150 C. 2 |
| 10 H2O | | | | | | | | | | | hours |
| n-Hexane | CS11 | 32.6 | 17.5 | 35% | 48.3 | 17.8 | 15.5 | 32% | 115% | 98% | 150 C. 2 |
| | | | | | | | | | | | hours |
| n-Pentanol | CS11 | 32.5 | 17.5 | 35% | 49.6 | 20.1 | 15.2 | 31% | 132% | 96% | 150 C. 2 |
| | | | | | | | | | | | hours |
| n-Octanol | CS11 | 32.5 | 17.5 | 35% | 49.6 | 21.4 | 15.3 | 31% | 140% | 97% | 150 C. 2 |
| | | | | | | | | | | | hours |

TABLE 2

| | | | | | | Filtrate | Scraped | | Viscosity | Viscosity | Viscosity | Viscosity |
|---|---|---|---|---|---|---|---|---|---|---|---|---|
| | | Mass | Mass | | Diluted | mesh | residual | Solution | (cp) | (cp) | (cp) | (cp) |
| Solvent | SG | Solvent | SG | % SG | Solution | mass | mass | Conc. | 6 rpm | 12 rpm | 30 rpm | 60 rpm |
| IPA | CS11 | 5.8 | 2.5 | 30% | 495.3 | 0.5 | 0 | 0.50% | 20 | 0 | 2 | 6 |
| None | CS11 | 0 | 2.5 | 100% | 478.5 | 4.5 | 4.2 | 0.52% | 15 | 0 | 3 | 4 |
| n-Heptane | CS11 | 5.8 | 2.5 | 30% | 499.1 | 2 | 1.5 | 0.50% | 5 | 2.5 | 6 | 6.5 |
| None | CS11 | 0 | 2.5 | 100% | 493.8 | 5.6 | 7.3 | 0.51% | 5 | 0 | 1 | 3.5 |
| n-Butanol | CS11 | 5.8 | 2.5 | 30% | 499.9 | 0.7 | 0 | 0.50% | 20 | 7.5 | 3 | 5.5 |
| Tween 20 | CS11 | 5.8 | 2.5 | 30% | 495.9 | 1.7 | 0 | 0.50% | 15 | 0 | 4 | 5.5 |
| Mineral Oil | CS11 | 5.8 | 2.5 | 30% | 499.9 | 1.2 | 0.3 | 0.50% | 20 | 2.3 | 3 | 7.5 |
| Ethanol | CS11 | 5.8 | 2.5 | 30% | 487.7 | 0.7 | 0 | 0.51% | 5 | 2.5 | 2 | 5.5 |
| IPA | CS11 | 5.8 | 2.5 | 30% | 482.3 | 0.3 | 0 | 0.52% | 10 | 7.5 | 3 | 5.5 |
| Pentanol | CS11 | 5.8 | 2.5 | 30% | 499 | 1 | 0 | 0.50% | 0 | 2.5 | 3 | 6.5 |
| Octanol | CS11 | 5.8 | 2.5 | 30% | 494.5 | 0.7 | 0 | 0.51% | 5 | 7.5 | 2 | 5.5 |
| n-Heptane | CS11 | 5.8 | 2.5 | 30% | 502.2 | 1.2 | 6.4 | 0.50% | 5 | 7.5 | 2 | 5.5 |

### Example 27

Production of Beta Glucan Material (Scleroglucan) used in Examples 22 and 23

Using a 5000 liter jacketed vessel with moderate agitation, 7 g/L of commercial Actigum CS6 from Cargill is added to 2400 liters of 11.8° C. water and mixed for 1 hour. After an hour of mixing, the vessel is heated to 85° C. and left under agitation for 12 hours without temperature control. After 12 hours the temperature is 41.3° C. and the vessel is reheated to 80° C. and passed through a Guerin homogenizer (ALM6; Series B 8250 30 000; Year 1998) at 200 bar of pressure and 3001/hr.

The homogenized mixture is cooled to 50° C. 4 g/L of CaCl₂*2H₂O was added. pH is reduced to 1.81 using 20% HCl. This mixture is agitated for 30 minutes to enable precipitation of oxalic acid.

After maturation, the solution is adjusted back to 5.62 pH using 10% Na₂CO₃ and heated to 85° C. and left under agitation without temperature control for 14 hours the reheated to 80° C.

After reaching 80° C. 20 g/L of Dicalite 4158 filter aid is added to the vessel and mixed for 10 minutes.

After mixing, the solution is fed to a clean Choquenet 12 m² press filter with Sefar Fyltris 25080 AM filter clothes at 1400 L/hr recycling the product back to the feed tank for 10 minutes. At the end of recycle, the flow is adjusted to 1300 L/hr and passed through the filter. Once the tank is empty an additional 50 liters of water is pushed into the filter. The fluid from this water flush and a 12 bar compression of the cake is both added to the collected permeate. The filter is cleaned after use.

The filtered permeate, water flush, and compression fluid is agitated and heated back to 80° C.

The heated mixture has 6 kg of Dicalite 4158 added and mixed for 10 minutes. At 1400 L/hr this solution is recycled through a clean Choquenet 12 m² press filter with Sefar Fyltris 25080 AM filter clothes at 1400 L/hr for 15 minutes. After the recycle, the tank is passed through the filter at 1400 L/hr.

Without cleaning the filter, 5.33 g/L of Clarcel ® DICS and 6.667 g/L of Clarcel ® CBL is added to the mixture and agitated for one hour while maintaining temperature at 80° C. This mixture is then recycled through the Dicalite coated Choquenet 12 m² press filter with Sefar Fyltris 25080 AM filter clothes at 1400 L/hr for 15 minutes. After the recycle, the tank is passed through the filter at 1350 L/hr. An additional 50 liters of flush water is pushed through the filter and collected as permeate as well. Compression fluid from the filter is not captured.

This twice filtered material is heated to 85° C. and left agitated without temperature control for 14 hours. At this point the material is reheated to 80° C. for a third filtration step.

The heated mixture has 6 kg of Dicalite 4158 added and mixed for 10 minutes. At 1400 L/hr this solution is recycled through a clean Choquenet 12 m² press filter with Sefar Fyltris 25080 AM filter clothes at 1400 L/hr for 15 minutes. After the recycle, the tank is passed through the filter at 1450 L/hr.

Without cleaning the filter, 5.33 g/L of Clarcel ® DICS and 6.667 g/L of Clarcel ® CBL is added to the mixture and agitated for one hour while maintaining temperature at 80° C. This mixture is then recycled through the Dicalite coated Choquenet 12 m² press filter with Sefar Fyltris 25080 AM filter clothes at 1600 L/hr for 15 minutes. After the recycle, the tank is passed through the filter at 1700 L/hr. An additional 50 liters of flush water is pushed through the filter and collected as permeate as well. Compression fluid from the filter is not captured.

The triple filtered permeate is cooled to 60° C. and mixed with 83% IPA at a 1:2 ratio, 2 g IPA solution for each g of scleroglucan solution. This precipitates scleroglucan fibers which can be mechanical separated from the bulk solution. In this example, a tromel separator is used to partition the precipitated fibers from the bulk liquid solution.

After recovery of the fibers they are washed with another 0.5 g 83% IPA solution for each 1 g of initial triple filtered permeate scleroglucan solution.

Wash fibers are dried in an ECI dryer (Volume 100 litres; Type 911-10; Year 1987) with 95° C. hot water for 1 hour and 13 minutes to produce a product with 89.3% dry matter. This material is ground up and sieved to provide powder smaller in size than 250 micron. This final ground scleroglucan material is the beta glucan material described herein and is used in some of the examples.

1. A suspension comprising about 10-60 wt % of beta glucan wherein the swelling of the suspended beta glucan ranges from about 120% to about 200%.

2. The suspension of claim 1 wherein the swelling ranges from about 125% to about 170%.

3. The suspension of claim 1 wherein the swelling ranges from about 130% to about 150%.

4. The suspension of claim 1 comprising 30-60 wt % beta glucan.

5. The suspension of claim 1 comprising 40-60 wt % beta glucan.

6. The suspension of claim 1 wherein the suspension comprises a hydrophilic solvent as a carrier fluid.

7. The suspension of claim 1, wherein the suspension is flowable.

8. The suspension of claim 1, wherein the suspension is dispersible.

9. A suspension comprising about 30-60 wt % of beta glucan wherein the swelling of the suspended beta glucan ranges from about 100% to about 140%.

10. A suspension comprising about 40-60 wt % of beta glucan wherein the swelling of the suspended beta glucan ranges from about 100% to about 135%.

11. A suspension comprising about 10-60 wt % of beta glucan wherein the swelling of the suspended beta glucan ranges from about 120% to about 200%.

12.-14. (canceled)

15. The suspension of claim 1 wherein the beta glucan is a scleroglucan.

16. The suspension of claim 9 wherein the beta glucan is a scleroglucan.
